(19) United States
(12) Patent Application Publication
(10) Pub. No.: US 2024/0239345 A1
(43) Pub. Date: Jul. 18, 2024

(54) VEHICLE CONTROL APPARATUS AND VEHICLE CONTROL METHOD

(71) Applicant: Mitsubishi Electric Corporation, Tokyo (JP)

(72) Inventors: Tomoki Uno, Tokyo (JP); Takuji Morimoto, Tokyo (JP); Taku Umeda, Tokyo (JP); Yuta Takashima, Tokyo (JP)

(73) Assignee: Mitsubishi Electric Corporation, Tokyo (JP)

(21) Appl. No.: 18/388,062

(22) Filed: Nov. 8, 2023

(30) Foreign Application Priority Data
Jan. 12, 2023 (JP) 2023-002817

(51) Int. Cl. B60W 30/18; B60W 30/095

(52) U.S. Cl. CPC B60W 30/18163; B60W 30/0956; B60W 40/04; B60W 2552/10; B60W 2554/4041; B60W 2554/802; B60W 2720/10

(57) ABSTRACT

To provide a vehicle control apparatus and a vehicle control method that makes it easy for the other vehicle to change lanes in back of the ego vehicle, by controlling the travel behavior of the ego vehicle, when the other vehicle is estimated to change lanes in back of the ego vehicle. A vehicle control apparatus acquires a periphery state of an ego vehicle, and a traveling state of an ego vehicle; estimates relative positions of one ore more other vehicles which travel on an adjacent lane adjacent to an ego lane where the ego vehicle is traveling, after a lane change to the ego lane, based on the periphery state and the traveling state; and increases a speed of the ego vehicle, when the relative position of the other vehicle after the lane change is in back of the ego vehicle.

### INCORPORATION BY REFERENCE

The disclosure of Japanese Patent Application No. 2023-002817 filed on Jan. 12, 2023 including its specification, claims and drawings, is incorporated herein by reference in its entirety.

### BACKGROUND

The present disclosure relates to a vehicle control apparatus and a vehicle control method.

In the technology of JP 2021-014175 A, when an ego vehicle is following behind a preceding vehicle and an other vehicle which is traveling on an adjacent lane of an ego lane is estimated to interrupt between the preceding vehicle and the ego vehicle, a first operation is performed to shorten a vehicle distance between the preceding vehicle and the ego vehicle and make it difficult to interrupt. Then, after a predetermined time has elapsed, when the other vehicle is still trying to interrupt between the preceding vehicle and the ego vehicle, the vehicle distance between the preceding vehicle and the ego vehicle is lengthened, and the other vehicle is made to interrupt.

In the technology of JP 6811303 B, a possibility that the other vehicle which is traveling in a range of the adjacent lane corresponding to between the preceding vehicle and the ego vehicle changes lanes between the preceding vehicle and the ego vehicle is estimated. And, the speed of the ego vehicle is made to approach the speed of the other vehicle as the possibility becomes high, and the speed of the ego vehicle is made to approach the speed of the preceding vehicle as the possibility becomes low.

### SUMMARY

However, in the technology of JP 2021-014175 A, when the other vehicle interrupts between the preceding vehicle and the ego vehicle, after the first operation is performed to shorten the vehicle distance and make it difficult for the other vehicle to interrupt, the second operation is performed to lengthen the vehicle distance and make it easy for the other vehicle to interrupt. Accordingly, variation of the vehicle distance becomes large, and it gives the occupants of the ego vehicle uncomfortable feeling. Since the vehicle distance is shorten and the other vehicle is made difficult to interrupt, the lane change of the other vehicle is disturbed, and a smooth lane change is not performed. Only the case where the other vehicle changes lanes between the preceding vehicle and the ego vehicle is considered, but the case where the other vehicle changes lanes in back of the ego vehicle is not considered.

In the technology of JP 6811303 B, only the case where the other vehicle changes lanes between the preceding vehicle and the ego vehicle is considered, but the case where the other vehicle changes lanes in back of the ego vehicle is not considered.

Then, the purpose of the present disclosure is to provide a vehicle control apparatus and a vehicle control method that makes it easy for the other vehicle to change lanes in back of the ego vehicle, by controlling the travel behavior of the ego vehicle, when the other vehicle is estimated to change lanes in back of the ego vehicle.

A vehicle control apparatus according to the present disclosure, including:
an information acquisition unit that acquires a periphery state of an ego vehicle, and a traveling state of the ego vehicle;
a lane change prediction unit that estimates relative positions of one or more other vehicles which travel on an adjacent lane adjacent to an ego lane where the ego vehicle is traveling, after a lane change to the ego lane, with respect to the ego vehicle, based on the periphery state and the traveling state; and
a vehicle control unit that increases a speed of the ego vehicle, when the relative position of the other vehicle after the lane change is in back of the ego vehicle.

A vehicle control method according to the present disclosure, including:
an information acquisition step of acquiring a periphery state of an ego vehicle, and a traveling state of the ego vehicle;
a lane change prediction step of estimating relative positions of one or more other vehicles which travel on an adjacent lane adjacent to an ego lane where the ego vehicle is traveling, after a lane change to the ego lane, with respect to the ego vehicle, based on the periphery state and the traveling state; and
a vehicle control step of increasing a speed of the ego vehicle, when the relative position of the other vehicle after the lane change is in back of the ego vehicle.

According to the vehicle control apparatus and the vehicle control method of the present disclosure, the relative positions of one or more other vehicles which travel on the adjacent lane, after the lane change to the ego lane, with respect to the ego vehicle is estimated, based on the periphery state of the ego vehicle, and the traveling state of the ego vehicle. And, when the relative position of the other vehicle after the lane change is in back of the ego vehicle, the speed of the ego vehicle is increased. Accordingly, by increasing the speed of the ego vehicle, the other vehicle changes lanes easily in back of the ego vehicle, the lane change can be facilitated, and the traveling safety can be improved.

### BRIEF DESCRIPTION OF THE DRAWINGS

FIG. 1 is a schematic block diagram of the vehicle control apparatus according to Embodiment 1;

FIG. 2 is a schematic hardware configuration diagram of the vehicle control apparatus according to Embodiment 1;

FIG. 3 is a schematic hardware configuration diagram of the vehicle control apparatus according to Embodiment 1;

FIG. 4 is a figure for explaining the ego vehicle coordinate system according to Embodiment 1;

FIG. 5 is a schematic diagram for explaining estimation of the lane change of the adjacent vehicle according to Embodiment 1;

FIG. 6 is a schematic diagram for explaining estimation of the lane change of the adjacent vehicle according to Embodiment 1;

FIG. 7 is a figure for explaining estimation of the lane change using the boundary line according to Embodiment 1;

FIG. 8 is a schematic diagram for explaining estimation of the lane change of the adjacent vehicle according to Embodiment 1;

FIG. 9 is a schematic diagram for explaining estimation of the lane change of the adjacent vehicle according to Embodiment 1;

FIG. 10 is a schematic diagram for explaining estimation of the lane change of the adjacent vehicle according to Embodiment 1;

FIG. 11 is a schematic diagram for explaining the behavior of the lane change by the speed increase according to Embodiment 1;

FIG. 12 is a schematic diagram for explaining the behavior of the lane change by the speed increase according to Embodiment 1;

FIG. 13 is a figure for explaining setting of the speed increase amount according to the relative position according to Embodiment 1;

FIG. 14 is a figure for explaining setting of the speed increase amount according to the relative speed according to Embodiment 1;

FIG. 15 is a figure for explaining setting of the speed increase amount according to the relative position according to Embodiment 1;

FIG. 16 is a figure for explaining setting of the speed increase amount according to the relative speed according to Embodiment 1;

FIG. 17 is a figure for explaining setting of the speed increase amount according to the time to collision according to Embodiment 1;

FIG. 18 is a figure for explaining setting of the speed increase amount according to the time to collision according to Embodiment 1;

FIG. 19 is a figure for explaining setting of the correction coefficient according to the probability or the priority according to Embodiment 1;

FIG. 20 is a schematic diagram for explaining the case where the speed increase is not performed according to Embodiment 1;

FIG. 21 is a schematic diagram for explaining the case where the relative position after the lane change changed according to Embodiment 1; and

FIG. 22 is a flowchart for explaining schematic processing of the vehicle control apparatus according to Embodiment 1.

### DETAILED DESCRIPTION OF THE EMBODIMENTS

### 1. Embodiment 1

A vehicle control apparatus 1 according to Embodiment 1 will be explained with reference to drawings. In the present embodiment, the vehicle control apparatus 1 is provided in an ego vehicle.

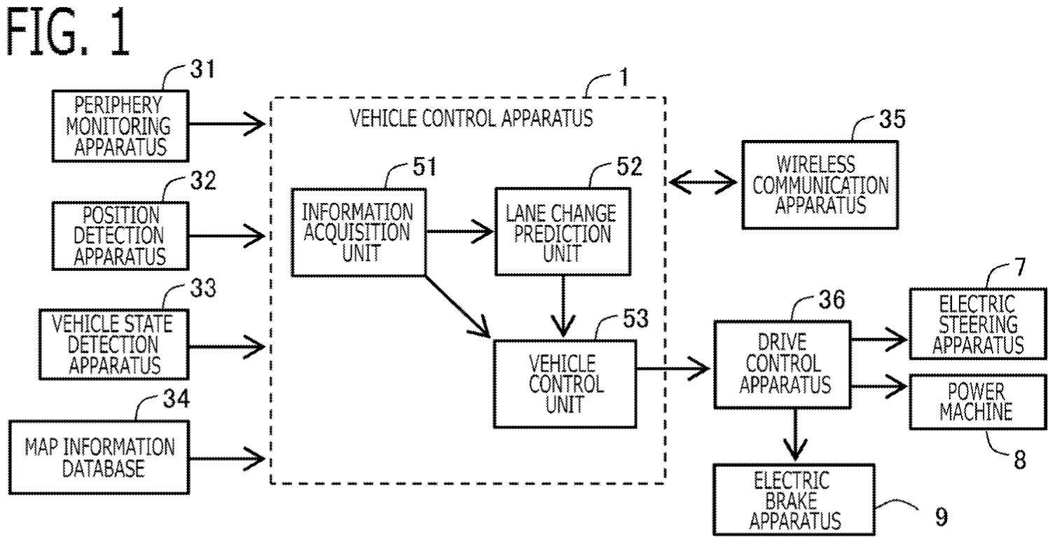

As shown in FIG. 1, the ego vehicle is provided with a periphery monitoring apparatus 31, a position detection apparatus 32, a vehicle state detection apparatus 33, a map information database 34, a wireless communication apparatus 35, a vehicle control apparatus 1, a drive control apparatus 36, a power machine 8, an electric steering apparatus 7, an electric brake apparatus 9, and the like.

The periphery monitoring apparatus 31 is an apparatus which monitors the periphery of vehicle, such as a camera and a radar. As the radar, a millimeter wave radar, a laser radar, an ultrasonic radar, and the like are used. The wireless communication apparatus 35 performs a wireless communication with a base station, using the wireless communication standard of cellular communication system, such as 4G and 5G.

The position detecting apparatus 32 is an apparatus which detects the present position (latitude, longitude, altitude) of the ego vehicle, and a GPS antenna which receives the signal outputted from satellites, such as GNSS (Global Navigation Satellite System), is used. For detection of the present position of the ego vehicle, various kinds of methods, such as the method using the traveling lane identification number of the ego vehicle, the map matching method, the dead reckoning method, and the method using the detection information around the ego vehicle, may be used.

In the map information database 34, road information, such as a road shape (for example, a lane number, a position of each lane, a shape of each lane, a type of each lane, a road type, a limit speed, and the like), a sign, and a road signal, is stored. The map information database 34 is mainly constituted of a storage apparatus. The map information database 34 may be provided in a server outside the vehicle connected to the network, and the vehicle control apparatus 1 may acquire required road information from the server outside the vehicle via the wireless communication apparatus 35.

As the drive control apparatus 36, a power controller, a brake controller, an automatic steering controller, a light controller, and the like are provided. The power controller controls output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

The vehicle condition detection apparatus 33 is a detection apparatus which detects an ego vehicle state which is a driving state and a traveling state of the ego vehicle. In the present embodiment, the vehicle state detection apparatus 33 detects a speed, an acceleration, a yaw rate, a steering angle, a lateral acceleration and the like of the ego vehicle, as the traveling state of the ego vehicle. For example, as the vehicle state detection apparatus 33, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 33, an accelerator position sensor, a brake position sensor, a steering angle sensor (handle angle sensor), a steering torque sensor, a direction indicator position switch, and the like are provided.

### 1-1. Vehicle Control Apparatus 1

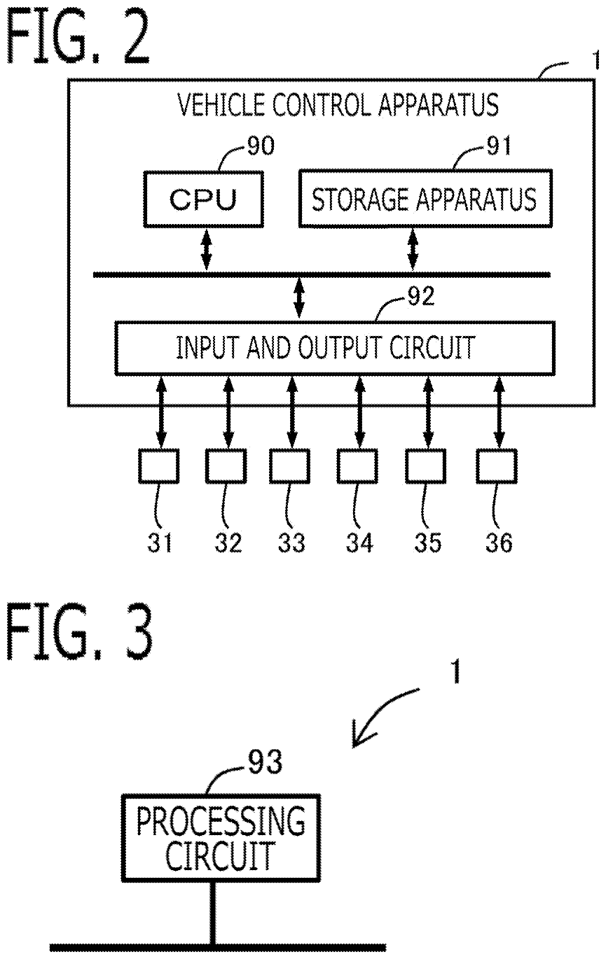

The vehicle control apparatus 1 is provided with functional units of an information acquisition unit 51, a lane change prediction unit 52, a vehicle control unit 53, and the like. Each function of the vehicle control apparatus 1 is realized by processing circuits provided in the vehicle control apparatus 1. As shown in FIG. 2, specifically, the vehicle control apparatus 1 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle state detection apparatus 33, the map information database 34, the wireless communication apparatus 35, and the drive control apparatus 36, and communicates with these devices.

Then, the arithmetic processor 90 runs software items (programs) stored in the storage apparatus 91 and collaborates with other hardware devices in the vehicle control apparatus 1, such as the storage apparatus 91, and the input and output circuit 92, so that the respective functions of the functional units 51 to 53 provided in the vehicle control apparatus 1 are realized. Setting data, such as a speed increase amount, utilized in the functional units 51 to 53 are stored in the storage apparatus 91, such as EEPROM.

Alternatively, as shown in FIG. 3, the vehicle control apparatus 1 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the vehicle control apparatus 1 will be described in detail below.

### 1-1-1. Information Acquisition Unit 51

The information acquisition unit 51 acquires a periphery state of the ego vehicle, and a traveling state of the ego vehicle. In the present embodiment, as the traveling state of the ego vehicle, the information acquisition unit 51 acquires a position, a moving direction, a speed, an acceleration, a presence or absence of lane change, and the like of the ego vehicle, based on the position information on the ego vehicle acquired from the position detection apparatus 32, and the ego vehicle state acquired from the vehicle state detection apparatus 33.

As the periphery state of the ego vehicle, the information acquisition unit 51 acquires a traveling state of an other vehicle which exists around the ego vehicle. In the present embodiment, the information acquisition unit 51 acquires a position, a moving direction, a speed, an acceleration, a presence or absence of lane change, and the like of the other vehicle, based on the detection information acquired from the periphery monitoring apparatus 31, and the position information on the ego vehicle acquired from the position detection apparatus 32. The information acquisition unit 51 also acquires information of an obstacle, a pedestrian, a sign, a traffic regulation such as lane regulation, and the like, other than the other vehicle.

The information acquisition unit 51 can acquire the traveling state of the other vehicle, and the lane information of the other vehicle from the outside of the ego vehicle by communication. For example, the information acquisition unit 51 may acquire the traveling state of the other vehicle (the position, the moving direction, the speed, the presence or absence of lane change, a target traveling trajectory, and the like of the other vehicle) from the other vehicle by the wireless communication and the like. From roadside machines, such as a camera which monitors the condition of road, the traveling state of the other vehicle (the position, the moving direction, the speed, the acceleration, an operation state of the direction indicator, and the like of the other vehicle), the information of the obstacle, the pedestrian, and the like, which exist in a monitor area, a road shape, a traffic regulation, a traffic state, and the like may be acquired by the wireless communication and the like.

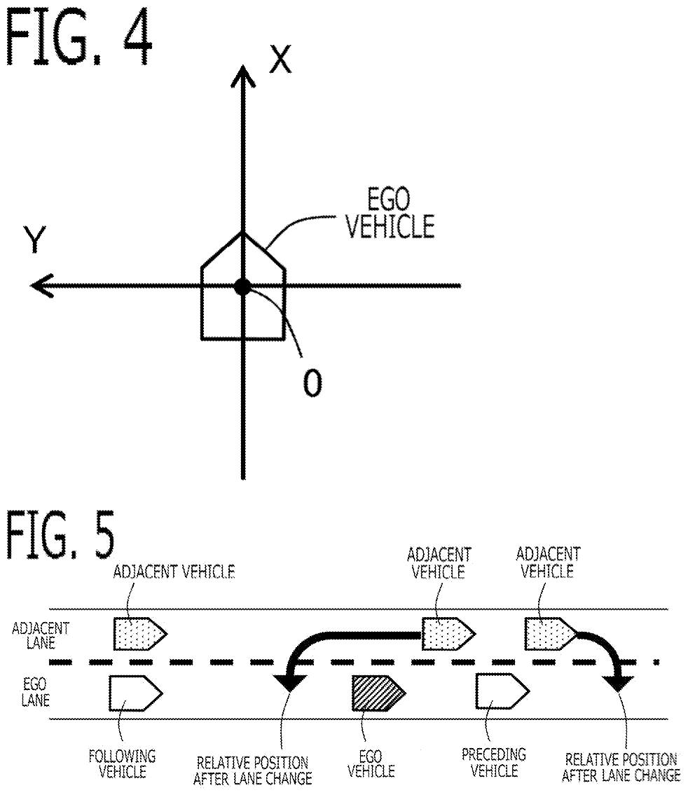

In the present embodiment, the information acquisition unit 51 acquires a relative position and a relative speed of the other vehicle and the like with respect to the ego vehicle in an ego vehicle coordinate system on the basis of the present position of the ego vehicle. As shown in FIG. 4, the ego vehicle coordinate system is a coordinate system which has two axes of a longitudinal direction X and a lateral direction Y of the present ego vehicle. The information acquisition unit 51 may acquire the relative position and the relative speed of the other vehicle in a coordinate system of a longitudinal direction and a lateral direction of the ego lane where the ego vehicle is traveling. The information acquisition unit 51 may acquire an absolute position (latitude, longitude), an absolute moving direction (azimuth), an absolute speed, an absolute acceleration, and the like of each vehicle.

As the periphery state of the ego vehicle, the information acquisition unit 51 acquires road information around the ego vehicle from the map information database 34, based on the position information of the ego vehicle acquired from the position detection apparatus 32. The acquired road information includes the lane number, the position of each lane, the shape of each lane, the type of each lane, the road type, the limit speed, and the like.

The information acquisition unit 51 detects a shape and a type of a lane marking and the like of the road, based on the detection information on the lane marking, such as a white line and a road shoulder, acquired from the periphery monitoring apparatus 31; and determines the shape and the position of each lane, the lane number, the type of each lane, and the like, based on the detected shape and the detected type of the lane marking of the road.

The information acquisition unit 51 acquires the lane information corresponding to an ego lane where the ego vehicle is traveling, based on the position of the ego vehicle. The information acquisition unit 51 acquires the lane information corresponding to a lane where each other vehicle is traveling, based on the position of each other vehicle. The shape, the position, and the type of lane and the lane information of the peripheral lane is included in the acquired lane information.

### 1-1-2. Lane Change Prediction Unit 52

As shown in FIG. 5, the lane change prediction unit 52 estimates relative positions of one or more other vehicles (hereinafter, referred to also as adjacent vehicles) which travel on an adjacent lane adjacent to an ego lane where the ego vehicle is traveling, after a lane change to the ego lane, with respect to the ego vehicle, based on the periphery state of the ego vehicle and the traveling state of the ego vehicle.

The lane change prediction unit 52 determines one or more other vehicles (the adjacent vehicles) which are traveling on the adjacent lane, based on the position information of each other vehicle, and the road information (the shape, the position, and the like of each lane). Then, the lane change prediction unit 52 estimates whether or not the adjacent vehicle of a prediction object changes lanes to the ego lane, and estimates the relative position with respect to the ego vehicle after the lane change to the ego lane if changing lanes, based on the traveling state of the adjacent vehicle of the prediction object, the traveling state of each vehicle which exist around the adjacent vehicle of the prediction object, the road information, and the like.

For example, the lane change prediction unit 52 uses the traveling state (the position, the moving direction, the speed, acceleration, the operation state of the direction indicator, and the like) of the adjacent vehicle of the prediction object, vehicles other than the adjacent vehicle of the prediction object in the adjacent lane, the ego vehicle, the preceding vehicle of the ego vehicle, the following vehicle of the ego vehicle, and the like. As long as the relative position after the lane change with respect to the ego vehicle can be estimated, and various kinds of well-known methods are used.

As shown in FIG. 6, the lane change prediction unit 52 may estimate a plurality of the relative positions after the lane change, and a priority or a probability of each of the plurality of the relative positions after the lane change, about the adjacent vehicle of the prediction object.

For example, following methods are used.

### (First Method)

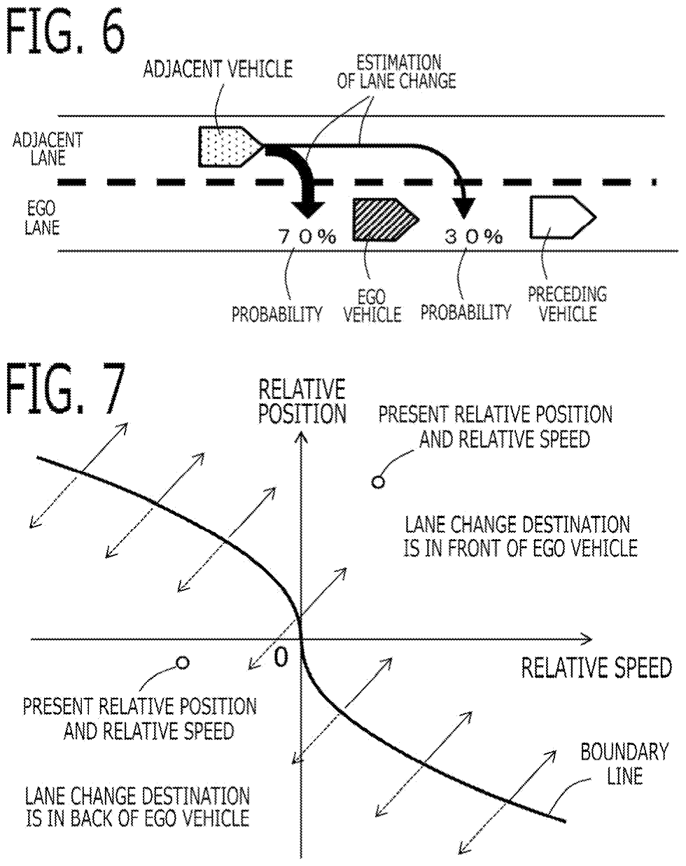

As shown in FIG. 7, a boundary line is set in a two-dimensional coordinate system which has axes of the relative position and the relative speed of the adjacent vehicle with respect to the ego vehicle; and whether the relative position of the adjacent vehicle with respect to the ego vehicle after the lane change to the ego lane becomes in front or in back of the ego vehicle is estimated, based on a relative positional relation between the relative position and the relative speed of the present adjacent vehicle, and the boundary line.

### (Second Method)

Using a machine learning model, such as SVM (Support Vector Machine) and the decision tree, whether the relative position of the adjacent vehicle with respect to the ego vehicle after the lane change to the ego lane becomes in front or in back of the ego vehicle is estimated. As the estimation using SVM, for example, the technology disclosed in “Estimation of Inter-Vehicle Gap Choice of Other Vehicles in the Case of Mandatory Lane-Change Considering Inter-Vehicle Interactions”, Sugimoto, et al., May 2019, 2019 Spring JSAE Annual Congress proceedings” can be used. As the method using machine learning, for example, the technology disclosed in WO 2019/104112 A can be used.

### (Third Method)

A lane change trajectory of the adjacent vehicle is estimated using evaluation of collision safety, such as the risk potential; and by comparing the lane change trajectory with the future trajectory of the ego vehicle, whether the relative position after the lane change becomes in front or in back of the ego vehicle is estimated. As the method using the risk potential, the technology disclosed in JP 7151179 B can be used, for example.

### (Fourth Method)

Based on the lane change behavior of the adjacent vehicle, the lighting of the direction indicator, and the like, the presence or absence of the lane change, and the relative position after the lane change are estimated.

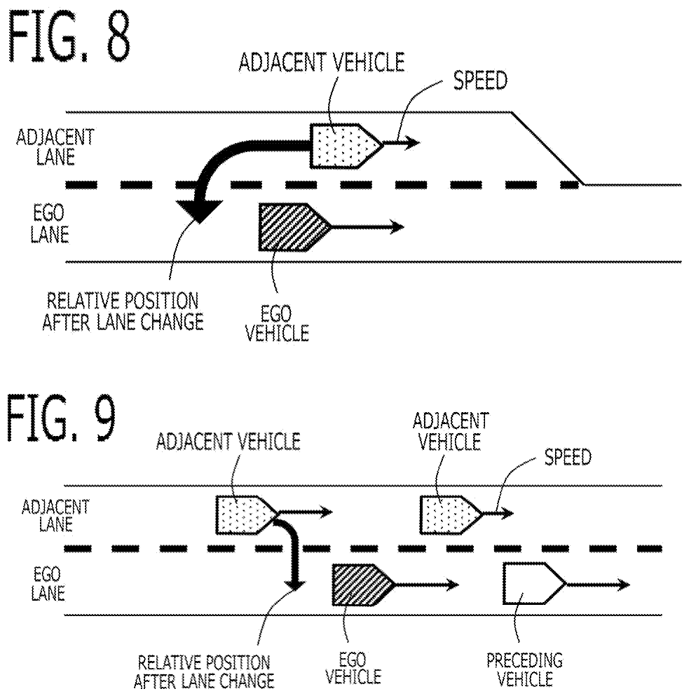

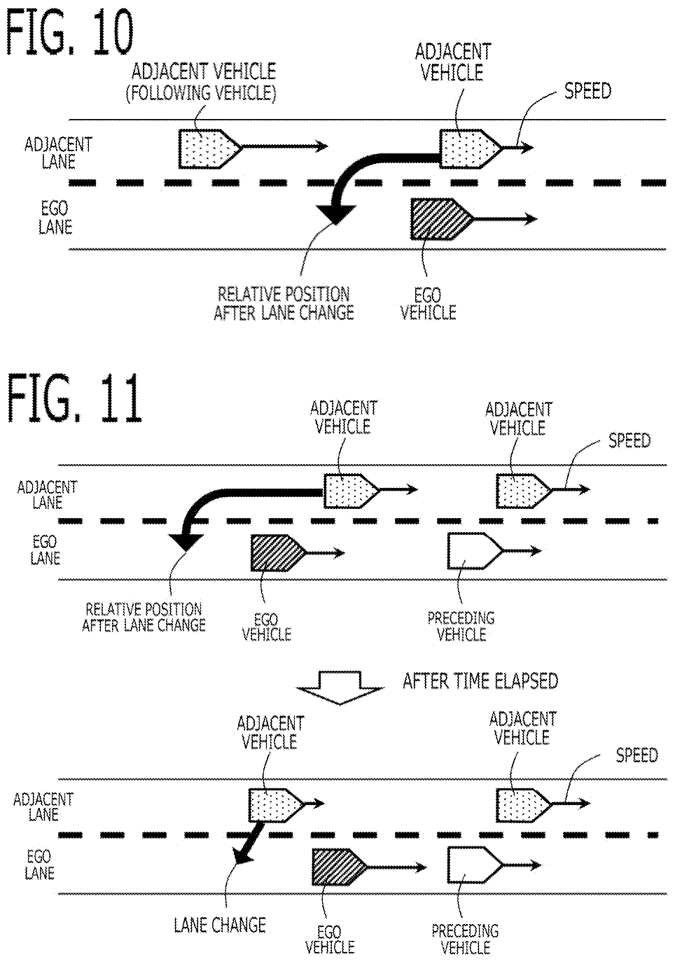

As conditions where the adjacent vehicle changes lanes to the ego lane, for example, there are a case where the front of the adjacent lane disappears and the adjacent vehicle merges into the ego lane, as shown in FIG. 8; a case where there is an obstacle in front of the adjacent lane and the adjacent vehicle changes lanes to the ego lane; a case where the adjacent vehicle changes lanes to the ego lane in order to overtake a preceding vehicle of a slow speed, as shown in FIG. 9; a case where the adjacent vehicle changes lanes to the ego lane in order to avoid a following vehicle of a fast speed, as shown in FIG. 10; and the like. And, the adjacent vehicle of such conditions is set as the prediction object.

Also when the lane change is started by a lane change behavior and a lighting of the direction indicator of the adjacent vehicle, the adjacent vehicle is set as the prediction object. Also when the lane change to the ego lane is included in a scheduled traveling route of the adjacent vehicle acquired by the vehicle-to-vehicle communications and the like, the adjacent vehicle is set as the prediction object. Also when the lane change is performed by various kinds of factors other than these, the adjacent vehicle is set as the prediction object.

### 1-1-3. Vehicle Control Unit 53

The vehicle control unit 53 controls at least a speed of the ego vehicle. For example, when a preceding vehicle exists on the ego lane in front of the ego vehicle, the vehicle control unit 53 increase or decreases the speed of the ego vehicle so that the vehicle distance between the ego vehicle and the preceding vehicle approaches a target vehicle distance. When a preceding vehicle does not exist on the ego lane in front of the ego vehicle, the vehicle control unit 53 increase or decreases the speed of the ego vehicle so that the speed of the ego vehicle approaches a target speed. In either case, the vehicle control unit 53 determines a target output torque, a target braking force, and the like which make the speed of the ego vehicle increase or decrease; and transmits to the power controller, the brake controller, and the like as the drive control apparatus 36. For example, the vehicle control unit 53 changes the target output torque, the target braking force, and the like by feedback control and the like so that an actual value approaches a target value, such as the target vehicle distance, the target speed, and a target acceleration. Then, the power controller controls the output torque of the power machines 8, such as the internal combustion engine and the motor, according to the target output torque. The brake controller controls the brake operation of the electric brake apparatus 9, according to the target braking force.

### <Speed Increase of Ego Vehicle>

In the present embodiment, when the relative position of the adjacent vehicle after the lane change is in back of the ego vehicle, the vehicle control unit 53 increases the speed of the ego vehicle.

According to this configuration, by increasing the speed of the ego vehicle, the adjacent vehicle changes lanes easily in back of the ego vehicle, the lane change can be facilitated, and the traveling safety can be improved.

In the present embodiment, when the relative position of the adjacent vehicle after the lane change is in back of the ego vehicle, and the adjacent vehicle is positioned on the adjacent lane in front or on side of the ego vehicle or a speed of the adjacent vehicle is larger than the speed of the ego vehicle, the vehicle control unit 53 increases the speed of the ego vehicle.

According to this configuration, as shown in FIG. 11, due to various kinds of factors, when the relative position of the adjacent vehicle after the lane change is in back of the ego vehicle and the adjacent vehicle is positioned on the adjacent lane in front or on side of the ego vehicle, the lane change of the adjacent vehicle is performed, after the relative speed of the adjacent vehicle with respect to the ego vehicle decreases, and the adjacent vehicle moves in back of the ego vehicle. In this case, since the speed of the ego vehicle is increased, the relative speed of the adjacent vehicle with respect to the ego vehicle decreases, the adjacent vehicle becomes easily in back of the ego vehicle, and the lane change is easily performed.

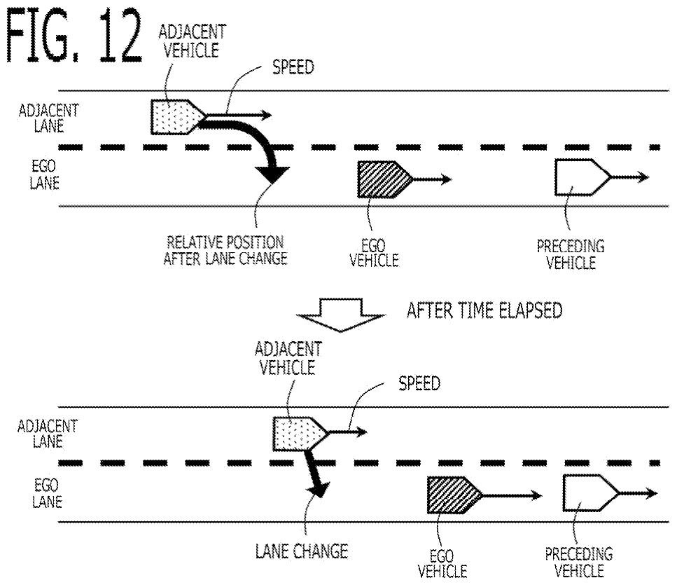

As shown in FIG. 12, due to various kinds of factors, when the relative position of the adjacent vehicle after the lane change is in back of the ego vehicle and the speed of the adjacent vehicle is larger than the speed of the ego vehicle, the lane change is performed after the relative speed of the adjacent vehicle with respect to the ego vehicle decreases. In this case, since the speed of the ego vehicle is increased, the relative speed of the adjacent vehicle decreases easily, and the lane change is easily performed. In this case, the adjacent vehicle may be positioned on the adjacent lane in front or on side of the ego vehicle.

When the relative position of the adjacent vehicle after the lane change is in back of the ego vehicle, and the adjacent vehicle is positioned on the adjacent lane in back of the ego vehicle and the speed of the adjacent vehicle is smaller than the speed of the ego vehicle, the vehicle control unit 53 does not increase the speed of the ego vehicle.

According to this configuration, due to various kinds of factors, when the relative position of the adjacent vehicle after the lane change is in back of the ego vehicle, and the adjacent vehicle is positioned on the adjacent lane in back of the ego vehicle and the speed of the adjacent vehicle is smaller than the speed of the ego vehicle, the adjacent vehicle can start the lane change in the present state. Accordingly, an unnecessary speed increase of the ego vehicle can be prevented.

### <Change of Speed Increase Amount ΔVin According to Relative Position and Relative Speed>

In a case of increasing the speed of the ego vehicle, the vehicle control unit 53 changes a speed increase amount ΔVin of the ego vehicle, based on at least one of the relative position and the relative speed with respect to the ego vehicle of the adjacent vehicle whose relative position after the lane change was estimated to be in back of the ego vehicle. Herein, for example, the relative position and the relative speed are calculated similarly to the relative distance ΔX and the relative speed ΔV which are described below using the equation (1).

According to this configuration, according to at least one of the relative position and the relative speed of the adjacent vehicle, the speed increase amount ΔVin of the ego vehicle which is desired for a smooth lane change is changed. Therefore, the speed increase amount ΔVin for the smooth lane change can be optimized.

The acceleration of the ego vehicle is enlarged as the speed increase amount ΔVin becomes large. Even when the speed increase amount ΔVin becomes large, the speed can be increased to the speed increase amount ΔVin in a short time.

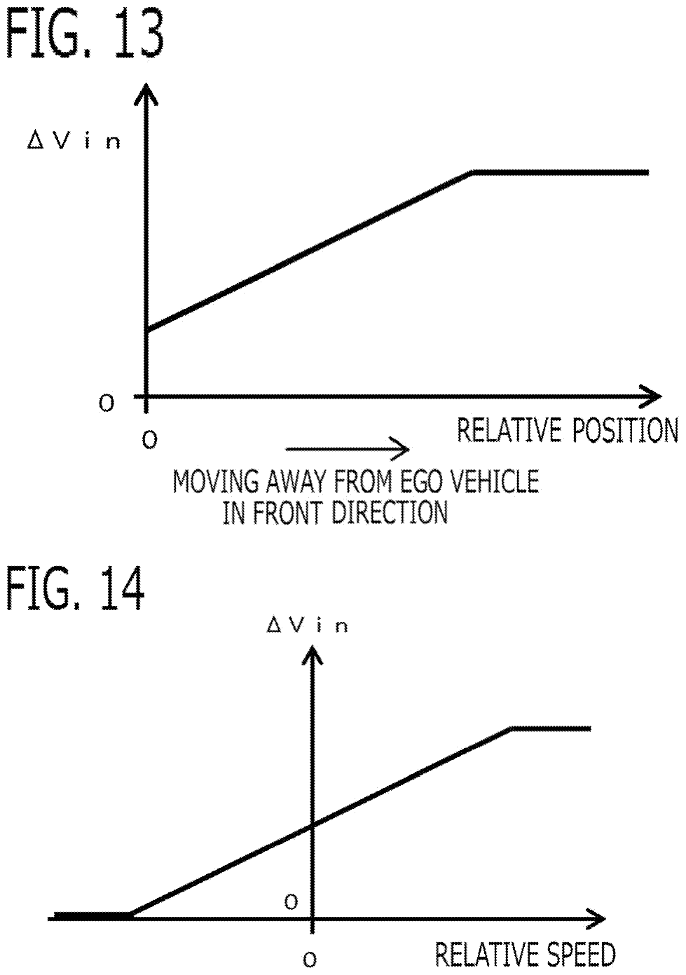

For example, when the relative position of the adjacent vehicle after the lane change is in back of the ego vehicle and the adjacent vehicle is positioned on the adjacent lane in front or on side of the ego vehicle, the vehicle control unit 53 increases the speed increase amount ΔVin, as the relative position of the adjacent vehicle with respect to the ego vehicle is moving away from the ego vehicle in the front direction, as shown in FIG. 13; and increases the speed increase amount ΔVin, as the relative speed of the adjacent vehicle with respect to the ego vehicle increases, as shown in FIG. 14.

According to this configuration, by increasing the speed increase amount ΔVin as the relative position of the adjacent vehicle is moving away from the ego vehicle in the front direction, the adjacent vehicle can be moved in back of the ego vehicle, and can carry out the lane change, in an early stage. By increasing the speed increase amount ΔVin as the relative speed of the adjacent vehicle increases, the adjacent vehicle can be moved in back of the ego vehicle and can carry out the lane change, in an early stage.

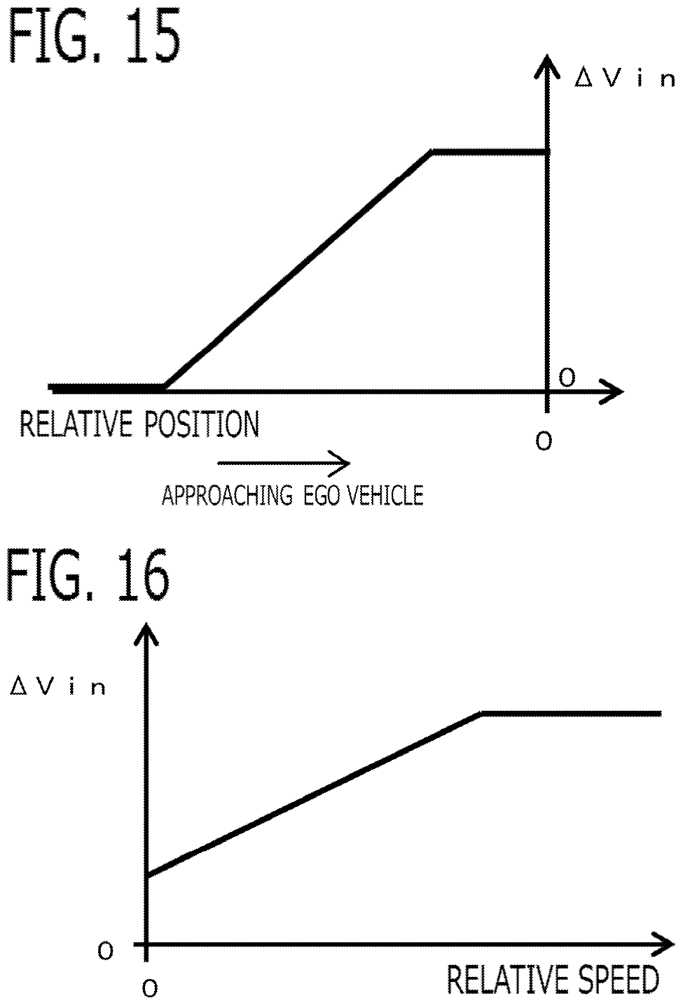

When the relative position of the adjacent vehicle after the lane change is in back of the ego vehicle, and the adjacent vehicle is positioned on the adjacent lane in back of the ego vehicle and the speed of the adjacent vehicle is larger than the speed of the ego vehicle, the vehicle control unit 53 increases the speed increase amount ΔVin, as the relative position of the adjacent vehicle with respect to the ego vehicle approaches the ego vehicle, as shown in FIG. 15; and increases the speed increase amount ΔVin, as the relative speed of the adjacent vehicle with respect to the ego vehicle increases, as shown in FIG. 16.

According to this configuration, by increasing the speed increase amount ΔVin as the relative position of the adjacent vehicle approaches the ego vehicle, the vehicle distance can be secured, and the adjacent vehicle can carry out the lane change, in an early stage. By increasing the speed increase amount ΔVin as the relative speed of the adjacent vehicle increases, the relative speed can be decreased, and the adjacent vehicle can carry out the lane change, in an early stage.

For example, by referring to a map data in which a relationship between the relative position of the adjacent vehicle with respect to the ego vehicle, the relative speed of the adjacent vehicle with respect to the ego vehicle, and the speed increase amount ΔVin (or a decrease amount of the target vehicle distance described below) is preliminarily set about each condition case, the vehicle control unit 53 calculates the speed increase amount ΔVin (or the decrease amount of the target vehicle distance) corresponding to the present relative speed and the present speed increase amount ΔVin.

### <Change of Speed Increase Amount ΔVin According to Time to Collision TTC>

Alternatively, when increasing the speed of the ego vehicle, the vehicle control unit 53 may change the speed increase amount ΔVin of the ego vehicle, based on the time to collision TTC between the adjacent vehicle and the ego vehicle whose relative position after the lane change is in back of the ego vehicle.

According to this configuration, according to the time to collision TTC, the speed increase amount ΔVin of the ego vehicle which is desired for a smooth lane change is changed. Therefore, the speed increase amount ΔVin for the smooth lane change can be optimized.

In the present embodiment, using the next equation, the vehicle control unit 53 calculates the time to collision TTC by dividing the relative distance ΔX of the adjacent vehicle with respect to the ego vehicle by the relative speed ΔV of the adjacent vehicle with respect to the ego vehicle.

TTC=−ΔX/ΔV

ΔX=Xobs−Xego

ΔV=Vobs−Vego (1)

Herein, Xobs is a position of the adjacent vehicle in the front direction of the ego vehicle coordinate system, or in the traveling direction of the lane. Xego is a position of the ego vehicle in the front direction of the ego vehicle coordinate system, or in the traveling direction of the lane. Vobs is a speed of the adjacent vehicle in the front direction of the ego vehicle coordinate system, or in the traveling direction of the lane. Vego is a speed of the ego vehicle in the front direction of the ego vehicle coordinate system, or in the traveling direction of the lane. Each vehicle position may be set to a center position of each vehicle, may be set to a front end position of each vehicle, or may be set to a rear end position of each vehicle. The position of the ego vehicle may be set to the front end position, and the position of the adjacent vehicle may be set to the rear end position. Conversely, the position of the ego vehicle may be set to the rear end position, and the position of the adjacent vehicle may be set to the front end position. As the relative distance ΔX, the vehicle distance of the adjacent vehicle with respect to the ego vehicle in the front direction of the ego vehicle coordinate system or in the traveling direction of the lane may be calculated.

When the adjacent vehicle is positioned on the adjacent lane in front of the ego vehicle (Xobs>Xego) and the speed of the adjacent vehicle is slower than the speed of the ego vehicle (Vobs<Vego), it becomes TTC>0. In this case, the time to collision TTC increases as the relative distance ΔX increases from 0, and the time to collision TTC increases as the relative speed ΔV increases.

When the adjacent vehicle is positioned on the adjacent lane in front or on side of the ego vehicle, and the speed of the adjacent vehicle is smaller than the speed of the ego vehicle, the vehicle control unit 53 increases the speed increase amount ΔVin of the ego vehicle as the time to collision TTC increases, as shown in FIG. 17.

According to this configuration, similarly to the above configuration, the absolute value of the time to collision TTC increases and the speed increase amount ΔVin increases, as the relative position of the adjacent vehicle with respect to the ego vehicle is moving away from the ego vehicle in the front direction. And, the time to collision TTC increases and the speed increase amount ΔVin increases, as the relative speed of the adjacent vehicle with respect to the ego vehicle increases toward 0. Accordingly, in an early stage, the adjacent vehicle can be moved in back of the ego vehicle, and can carry out the lane change.

On the other hand, when the adjacent vehicle is positioned on the adjacent lane in back of the ego vehicle (Xobs<Xego) and the speed of the adjacent vehicle is faster than the speed of the ego vehicle (Vobs>Vego), it becomes TTC>0. In this case, the time to collision TTC increases as the relative distance ΔX decreases from 0, and the time to collision TTC decreases as the relative speed ΔV increases from 0.

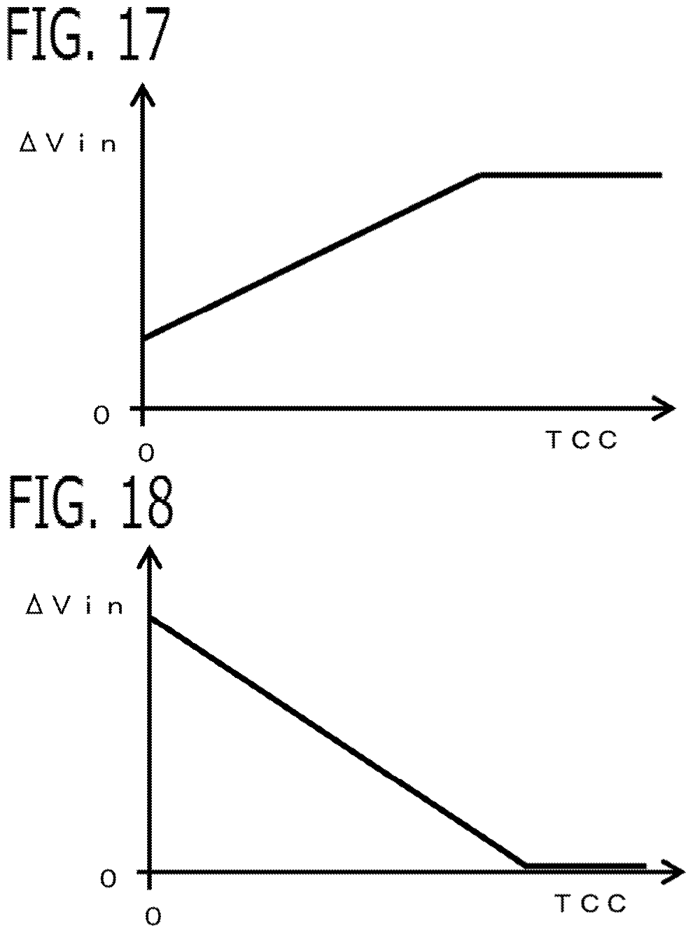

When the adjacent vehicle is positioned on the adjacent lane in back of the ego vehicle, and the speed of the adjacent vehicle is larger than the speed of the ego vehicle, the vehicle control unit 53 increases the speed increase amount ΔVin of the ego vehicle as the time to collision TTC decreases, as shown in FIG. 18.

According to this configuration, similarly to the above configuration, as the relative position of the adjacent vehicle with respect to the ego vehicle approach the ego vehicle, the time to collision TTC decreases and the speed increase amount ΔVin increases. As the relative speed of the adjacent vehicle with respect to the ego vehicle increases, the time to collision TTC decreases and the speed increase amount ΔVin increases. Accordingly, in an early stage, the vehicle distance can be secured, the relative speed can be decreased, and the adjacent vehicle can carry out the lane change.

### <Processing According to Probability>

As mentioned above, in the case where the lane change prediction unit 52 estimates the plurality of the relative positions after the lane change, and the priority or the probability of each of the plurality of the relative positions after the lane change, about the adjacent vehicle of the prediction object, following processings are performed.

When the relative position after the lane change whose probability or priority is highest is in back of the ego vehicle, the vehicle control unit 53 increases the speed of the ego vehicle. Then, the vehicle control unit 53 changes the speed increase amount ΔVin of the ego vehicle, based on the highest probability or priority. According to this configuration, based on the highest probability or priority, the speed increase amount ΔVin of the ego vehicle can be changed appropriately.

In the present embodiment, the vehicle control unit 53 decreases the speed increase amount ΔVin as the highest probability or priority decreases. According to this configuration, an unnecessary speed increase of the ego vehicle according to a prediction result with low probability or priority can be prevented.

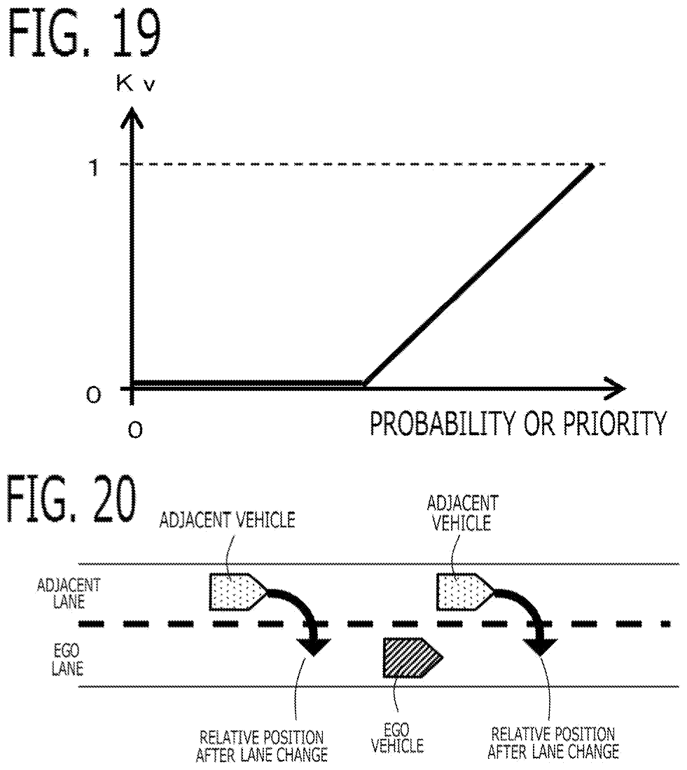

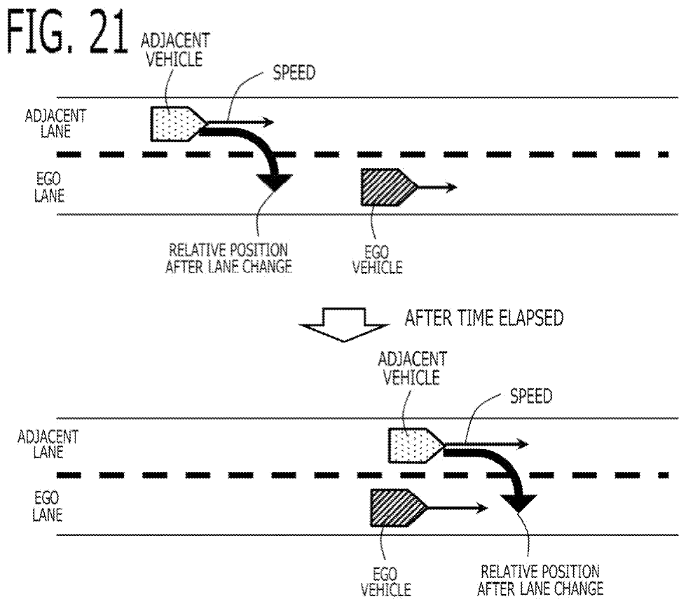

For example, the vehicle control unit 53 calculates the speed increase amount ΔVin, based on the relative position and the relative speed of the adjacent vehicle with respect to the ego vehicle, or the time to collision TTC, according to various kinds of methods mentioned above; and may calculate a value obtained by multiplying a correction coefficient Kv which is set based on the highest probability or priority, to this speed increase amount ΔVin, as a final speed increase amount ΔVin. As shown in FIG. 19, the correction coefficient Kv decreases from 1 as the highest probability or priority decreases.

Alternatively, the vehicle control unit 53 may not change the speed increase amount ΔVin of the ego vehicle, based on the highest probability or priority. That is, the probability or the priority is only used for selecting the relative position after the lane change with the highest probability or priority and determining whether or not it is in back of the ego vehicle, the speed increase amount ΔVin which is calculated based on the relative position and the relative speed of the adjacent vehicle with respect to the ego vehicle or the time to collision TTC may be used as it is.

### <When not Increasing Speed>

As shown in FIG. 20, when both of the adjacent vehicle whose relative position after the lane change are in back of the ego vehicle, and the adjacent vehicle whose relative position after the lane change are in front of the ego vehicle exist, the vehicle control unit 53 does not increase the speed of the ego vehicle.

In this case, if the speed of the ego vehicle is increased, the adjacent vehicle which changes lanes in back of the ego vehicle can change lanes easily, but, the adjacent vehicle which changes lanes in front of the ego vehicle becomes difficult to change lanes. Accordingly, in this case, by not increasing the speed of the ego vehicle, after estimating the lane changes in the present speed state of the ego vehicle, each adjacent vehicle can change lanes, and the lane change of each adjacent vehicle is not disturbed.

### <Return of Speed Increase>

When the adjacent vehicle whose relative position after the lane change is in back of the ego vehicle completes the lane change to the ego lane in back of the ego vehicle after increasing the speed of the ego vehicle, the vehicle control unit 53 returns the speed of the ego vehicle to the state before increasing.

According to this configuration, after the lane change of the adjacent vehicle is completed, the speed of an ego vehicle is returned to the state before increasing, and a normal traveling can be performed.

As shown in FIG. 21, after starting the increase in the speed of the ego vehicle, when the relative position after the lane change of the adjacent vehicle whose relative position after the lane change was estimated to be in back of the ego vehicle changes to in front of the ego vehicle, the vehicle control unit 53 returns the speed of the ego vehicle to the state before increasing.

According to this configuration, when the relative position of the adjacent vehicle after the lane change changes from in back to in front, by returning to the state before increasing the speed of the ego vehicle, the adjacent vehicle can be made easily change lanes in front of the ego vehicle.

### <Method of Speed Increase>

For example, in a case of increasing the speed of the ego vehicle when a preceding vehicle exists on the ego lane in front of the ego vehicle and a vehicle distance between the ego vehicle and the preceding vehicle is controlled, the vehicle control unit 53 increases the speed of the ego vehicle, by decreasing the target vehicle distance. When the target vehicle distance is decreased, the speed of the ego vehicle is increased for decreasing the vehicle distance. According to this configuration, since the speed of the ego vehicle is increased by the vehicle distance control, the speed of the ego vehicle is increased, while preventing the ego vehicle from colliding with the preceding vehicle, and the adjacent vehicle can change lanes easily in back of the ego vehicle.

When a decrease amount of the target vehicle distance becomes large, the speed increase amount increases. Accordingly, as the above change of the speed increase amount, the decrease amount of the target vehicle distance is changed. That is to say, the speed increase amount is replaced by the decrease amount of the target vehicle distance. The decrease amount (absolute value) of the target vehicle distance is upper-limited so that the target vehicle distance becomes a lower limit value or more.

As mentioned above, in the case of returning to the state before increasing the speed of the ego vehicle when a predetermined condition is established, the vehicle control unit 53 sets the decrease amount of the target vehicle distance to 0, and returns it to the state before decreasing the target vehicle distance.

In a case of increasing the speed of the ego vehicle when a preceding vehicle which needs to avoid a collision does not exist on the ego lane in front of the ego vehicle and the speed of the ego vehicle is controlled so as to approach the target speed, the vehicle control unit 53 increases the speed of the ego vehicle by increasing the target speed. When the target speed is increased, the output torque of the power machine 8 is increased, or the braking force of the electric brake apparatus 9 is decreased. According to this configuration, since the speed of the ego vehicle is increased by the target speed control when the preceding vehicle does not exist, the speed of the ego vehicle is increased without possibility that the ego vehicle collides with the preceding vehicle, and the adjacent vehicle changes lanes easily in back of the ego vehicle. As the above change of the speed increase amount, the change of the increase amount of the target speed is performed.

As mentioned above, in the case of returning to the state before increasing the speed of the ego vehicle when a predetermined condition is established, the vehicle control unit 53 sets the increase amount of the target speed to 0, and returns it to the state before increasing the target speed.

The vehicle control unit 53 may perform a steering control which changes the target steering angle so that the ego vehicle travels within the ego lane. Alternatively, the vehicle control unit 53 may generate a target traveling trajectory, and may change the target steering angle so that the ego vehicle travels along with the target traveling trajectory. The vehicle control unit 53 transmits the target steering angle to the automatic steering controller, and the automatic steering controller controls the electric steering apparatus 7 so that the steering angle follows the target steering angle.

Alternatively, in order to perform more high-level automatic driving, the vehicle control unit 53 may generate a time series target traveling trajectory. The time series target traveling trajectory is a time series traveling plan of a target position, a target traveling direction, a target speed, a target acceleration, and the like of the ego vehicle at each future time point. When increasing the speed of the ego vehicle, the vehicle control unit 53 increases the target speed and the target acceleration at each future time point, according to the increase amount of the target speed. The vehicle control unit 53 controls the vehicle so that the ego vehicle follows the target traveling trajectory. For example, the vehicle control unit 53 determines the target output torque, the target braking force, the target steering angle, the operation command of the direction indicator, and the like; and transmits each determined command value to the power controller, the brake controller, the automatic steering controller, the light controller, and the like as the drive control apparatus 36.

### <Flowchart>

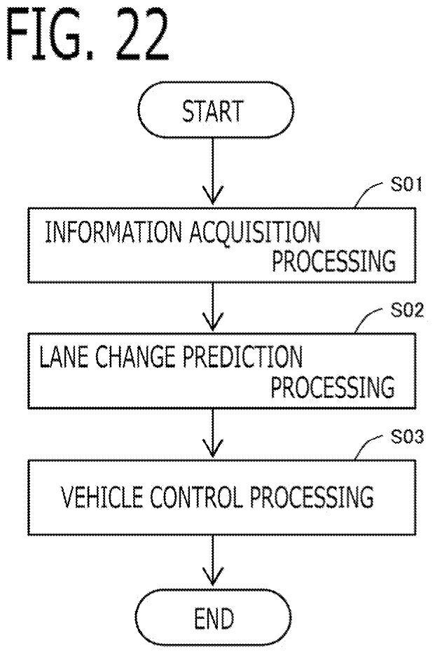

FIG. 22 is a schematic flowchart explaining processing of the vehicle control apparatus 1 (a vehicle control method) according to the present embodiment. Processing of FIG. 22 is executed at every predetermined calculation period, for example.

In the step S01, as mentioned above, the information acquisition unit 51 performs an information acquisition processing which acquires the periphery state of the ego vehicle, and the traveling state of the ego vehicle.

In the step S02, as mentioned above, the lane change prediction unit 52 performs a lane change estimation processing which estimates relative positions of one or more other vehicles which travel on the adjacent lane adjacent to the ego lane where the ego vehicle is traveling, after the lane change to the ego lane, with respect to the ego vehicle, based on the periphery state of the ego vehicle and the traveling state of the ego vehicle.

In the step S03, as mentioned above, when the relative position of the adjacent vehicle after the lane change is in back of the ego vehicle, the vehicle control unit 53 performs a vehicle control processing which increases the speed of the ego vehicle.

### Summary of Aspects of the Present Disclosure

Hereinafter, the aspects of the present disclosure is summarized as appendixes.

### (Appendix 1)

A vehicle control apparatus comprising:
an information acquisition unit that acquires a periphery state of an ego vehicle, and a traveling state of the ego vehicle;
a lane change prediction unit that estimates relative positions of one or more other vehicles which travel on an adjacent lane adjacent to an ego lane where the ego vehicle is traveling, after a lane change to the ego lane, with respect to the ego vehicle, based on the periphery state and the traveling state; and
a vehicle control unit that increases a speed of the ego vehicle, when the relative position of the other vehicle after the lane change is in back of the ego vehicle.

### (Appendix 2)

The vehicle control apparatus according to appendix 1,
wherein, when the relative position of the other vehicle after the lane change is in back of the ego vehicle, and the other vehicle is positioned on the adjacent lane in front or on side of the ego vehicle or a speed of the other vehicle is larger than the speed of the ego vehicle, the vehicle control unit increases the speed of the ego vehicle.

### (Appendix 3)

The vehicle control apparatus according to appendix 1 or 2,
wherein, when the relative position of the other vehicle after the lane change is in back of the ego vehicle, and the other vehicle is positioned on the adjacent lane in back of the ego vehicle and a speed of the other vehicle is smaller than the speed of the ego vehicle, the vehicle control unit does not increase the speed of the ego vehicle.

### (Appendix 4)

The vehicle control apparatus according to appendix 1 or 2,
wherein, when both of the other vehicle whose relative position after the lane change are in back of the ego vehicle, and the other vehicle whose relative position after the lane change are in front of the ego vehicle exist, the vehicle control unit does not increase the speed of the ego vehicle.

### (Appendix 5)

The vehicle control apparatus according to any one of appendices 1 to 4,
wherein, when the other vehicle whose relative position after the lane change is in back of the ego vehicle completes the lane change to the ego lane in back of the ego vehicle after increasing the speed of the ego vehicle, the vehicle control unit returns the speed of the ego vehicle to a state before increasing.

### (Appendix 6)

The vehicle control apparatus according to any one of appendices 1 to 5,
wherein, after starting an increase in the speed of the ego vehicle, when the relative position after the lane change of the other vehicle whose relative position after the lane change was estimated to be in back of the ego vehicle changes to in front of the ego vehicle, the vehicle control unit returns the speed of the ego vehicle to a state before increasing.

### (Appendix 7)

The vehicle control apparatus according to any one of appendices 1 to 6,
wherein, when increasing the speed of the ego vehicle, the vehicle control unit changes a speed increase amount of the ego vehicle, based on at least one of a relative position and a relative speed with respect to the ego vehicle of the other vehicle whose relative position after the lane change was estimated to be in back of the ego vehicle.

### (Appendix 8)

The vehicle control apparatus according to appendix 7,
wherein, in a case of increasing the speed of the ego vehicle,
when the other vehicle whose relative position after the lane change was estimated to be in back of the ego vehicle is positioned on the adjacent lane in front or on side of the ego vehicle, the vehicle control unit increases the speed increase amount, as the relative position of the other vehicle with respect to the ego vehicle is moving away from the ego vehicle in front direction, and increases the speed increase amount, as the relative speed of the other vehicle with respect to the ego vehicle increases; and
when the other vehicle whose relative position after the lane change was estimated to be in back of the ego vehicle is positioned on the adjacent lane in back of the ego vehicle, and the speed of the other vehicle is larger than the speed of the ego vehicle, the vehicle control unit increases the speed increase amount as the relative position of the other vehicle with respect to the ego vehicle approach the ego vehicle, and increases the speed increase amount, as the relative speed of the other vehicle with respect to the ego vehicle increases.

### (Appendix 9)

The vehicle control apparatus according to any one of appendices 1 to 6,
wherein, in a case of increasing the speed of the ego vehicle, the vehicle control unit changes a speed increase amount of the ego vehicle, based on a time to collision between the ego vehicle and the other vehicle whose relative position after the lane change is in back of the ego vehicle.

### (Appendix 10)

The vehicle control apparatus according to appendix 9,
wherein, in a case of increasing the speed of the ego vehicle,
when the other vehicle whose relative position after the lane change was estimated to be in back of the ego vehicle is positioned on the adjacent lane in front or on side of the ego vehicle, and the speed of the other vehicle is smaller than the speed of the ego vehicle, the vehicle control unit increases the speed increase amount of the ego vehicle, as the time to collision increases; and
when the other vehicle whose relative position after the lane change was estimated to be in back of the ego vehicle is positioned on the adjacent lane in back of the ego vehicle, and the speed of the other vehicle is larger than the speed of the ego vehicle, the vehicle control unit increases the speed increase amount, as the time to collision decreases.

### (Appendix 11)

The vehicle control apparatus according to any one of appendices 1 to 10,
wherein, the lane change prediction unit estimates a plurality of the relative positions of the other vehicle after the lane change to the ego lane, and a probability or a priority of each of the plurality of relative positions after the lane change, and
when the relative position after the lane change whose probability or priority is highest is in back of the ego vehicle, the vehicle control unit increases the speed of the ego vehicle, and changes a speed increase amount of the ego vehicle, based on the highest probability or priority.

### (Appendix 12)

The vehicle control apparatus according to appendix 11,
wherein the vehicle control unit decreases the speed increase amount, as the highest probability or priority decreases.

### (Appendix 13)

The vehicle control apparatus according to any one of appendices 1 to 12,
wherein, in a case of increasing the speed of the ego vehicle, the vehicle control unit increases the speed of the ego vehicle, by increasing a target speed of the ego vehicle, or decreasing a target vehicle distance between the ego vehicle and a front vehicle.

### (Appendix 14)

The vehicle control apparatus according to any one of appendices 1 to 12,
wherein, in a case of increasing the speed of the ego vehicle when a preceding vehicle exists on the ego lane in front of the ego vehicle and a vehicle distance between the ego vehicle and the preceding vehicle is controlled, the vehicle control unit increases the speed of the ego vehicle, by decreasing the target vehicle distance; and
in a case of increasing the speed of the ego vehicle when a preceding vehicle which needs to avoid a collision does not exist on the ego lane in front of the ego vehicle and the speed of the ego vehicle is controlled so as to approach the target speed, the vehicle control unit increases the speed of the ego vehicle, by increasing the target speed.

### (Appendix 15)

A vehicle control method comprising:
an information acquisition step of acquiring a periphery state of an ego vehicle, and a traveling state of the ego vehicle;
a lane change prediction step of estimating relative positions of one or more other vehicles which travel on an adjacent lane adjacent to an ego lane where the ego vehicle is traveling, after a lane change to the ego lane, with respect to the ego vehicle, based on the periphery state and the traveling state; and
a vehicle control step of increasing a speed of the ego vehicle, when the relative position of the other vehicle after the lane change is in back of the ego vehicle.

Although the present disclosure is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present disclosure. For example, at least one of the constituent components may be modified, added, or eliminated.

What is claimed is:

1. A vehicle control apparatus comprising at least one processor configured to implement:
an information acquisitor that acquires a periphery state of an ego vehicle, and a traveling state of the ego vehicle;
a lane change predictor that estimates relative positions of one or more other vehicles which travel on an adjacent lane adjacent to an ego lane where the ego vehicle is traveling, after a lane change to the ego lane, with respect to the ego vehicle, based on the periphery state and the traveling state; and
a vehicle controller that increases a speed of the ego vehicle, when the relative position of the other vehicle after the lane change is in back of the ego vehicle.

2. The vehicle control apparatus according to claim 1,
wherein, when the relative position of the other vehicle after the lane change is in back of the ego vehicle, and the other vehicle is positioned on the adjacent lane in front or on side of the ego vehicle or a speed of the other vehicle is larger than the speed of the ego vehicle, the vehicle controller increases the speed of the ego vehicle.

3. The vehicle control apparatus according to claim 1,
wherein, when the relative position of the other vehicle after the lane change is in back of the ego vehicle, and the other vehicle is positioned on the adjacent lane in back of the ego vehicle and a speed of the other vehicle is smaller than the speed of the ego vehicle, the vehicle controller does not increase the speed of the ego vehicle.

4. The vehicle control apparatus according to claim 1,
wherein, when both of the other vehicle whose relative position after the lane change are in back of the ego vehicle, and the other vehicle whose relative position after the lane change are in front of the ego vehicle exist, the vehicle controller does not increase the speed of the ego vehicle.

5. The vehicle control apparatus according to claim 1,
wherein, when the other vehicle whose relative position after the lane change is in back of the ego vehicle completes the lane change to the ego lane in back of the ego vehicle after increasing the speed of the ego vehicle, the vehicle controller returns the speed of the ego vehicle to a state before increasing.

6. The vehicle control apparatus according to claim 1,
wherein, after starting an increase in the speed of the ego vehicle, when the relative position after the lane change of the other vehicle whose relative position after the lane change was estimated to be in back of the ego vehicle changes to in front of the ego vehicle, the vehicle controller returns the speed of the ego vehicle to a state before increasing.

7. The vehicle control apparatus according to claim 1,
wherein, when increasing the speed of the ego vehicle, the vehicle controller changes a speed increase amount of the ego vehicle, based on at least one of a relative position and a relative speed with respect to the ego vehicle of the other vehicle whose relative position after the lane change was estimated to be in back of the ego vehicle.

8. The vehicle control apparatus according to claim 7,
wherein, in a case of increasing the speed of the ego vehicle,
when the other vehicle whose relative position after the lane change was estimated to be in back of the ego vehicle is positioned on the adjacent lane in front or on side of the ego vehicle, the vehicle controller increases the speed increase amount, as the relative position of the other vehicle with respect to the ego vehicle is moving away from the ego vehicle in front direction, and increases the speed increase amount, as the relative speed of the other vehicle with respect to the ego vehicle increases; and
when the other vehicle whose relative position after the lane change was estimated to be in back of the ego vehicle is positioned on the adjacent lane in back of the ego vehicle, and the speed of the other vehicle is larger than the speed of the ego vehicle, the vehicle controller increases the speed increase amount as the relative position of the other vehicle with respect to the ego vehicle approach the ego vehicle, and increases the speed increase amount, as the relative speed of the other vehicle with respect to the ego vehicle increases.

9. The vehicle control apparatus according to claim 1,
wherein, in a case of increasing the speed of the ego vehicle, the vehicle controller changes a speed increase amount of the ego vehicle, based on a time to collision between the ego vehicle and the other vehicle whose relative position after the lane change is in back of the ego vehicle.

10. The vehicle control apparatus according to claim 9,
wherein, in a case of increasing the speed of the ego vehicle,
when the other vehicle whose relative position after the lane change was estimated to be in back of the ego vehicle is positioned on the adjacent lane in front or on side of the ego vehicle, and the speed of the other vehicle is smaller than the speed of the ego vehicle, the vehicle controller increases the speed increase amount of the ego vehicle, as the time to collision increases; and
when the other vehicle whose relative position after the lane change was estimated to be in back of the ego vehicle is positioned on the adjacent lane in back of the ego vehicle, and the speed of the other vehicle is larger than the speed of the ego vehicle, the vehicle controller increases the speed increase amount, as the time to collision decreases.

11. The vehicle control apparatus according to claim 1,
wherein, the lane change predictor estimates a plurality of the relative positions of the other vehicle after the lane change to the ego lane, and a probability or a priority of each of the plurality of relative positions after the lane change, and
when the relative position after the lane change whose probability or priority is highest is in back of the ego vehicle, the vehicle controller increases the speed of the ego vehicle, and changes a speed increase amount of the ego vehicle, based on the highest probability or priority.

12. The vehicle control apparatus according to claim 11,
wherein the vehicle controller decreases the speed increase amount, as the highest probability or priority decreases.

13. The vehicle control apparatus according to claim 1,
wherein, in a case of increasing the speed of the ego vehicle, the vehicle controller increases the speed of the ego vehicle, by increasing a target speed of the ego vehicle, or decreasing a target vehicle distance between the ego vehicle and a front vehicle.

14. The vehicle control apparatus according to claim 1,
wherein, in a case of increasing the speed of the ego vehicle when a preceding vehicle exists on the ego lane in front of the ego vehicle and a vehicle distance between the ego vehicle and the preceding vehicle is controlled, the vehicle controller increases the speed of the ego vehicle, by decreasing the target vehicle distance; and
in a case of increasing the speed of the ego vehicle when a preceding vehicle which needs to avoid a collision does not exist on the ego lane in front of the ego vehicle and the speed of the ego vehicle is controlled so as to approach the target speed, the vehicle controller increases the speed of the ego vehicle, by increasing the target speed.

15. A vehicle control method comprising:
acquiring a periphery state of an ego vehicle, and a traveling state of the ego vehicle;
estimating relative positions of one or more other vehicles which travel on an adjacent lane adjacent to an ego lane where the ego vehicle is traveling, after a lane change to the ego lane, with respect to the ego vehicle, based on the periphery state and the traveling state; and
increasing a speed of the ego vehicle, when the relative position of the other vehicle after the lane change is in back of the ego vehicle.
